(19) United States
(12) Patent Application Publication
(10) Pub. No.: US 2003/0055760 A1
(43) Pub. Date: Mar. 20, 2003

(54) Method and system for asset management

(76) Inventor: Tsuneyuki Kubo, Tokyo (JP)

Correspondence Address: Tsuneyuki Kubo, 3-23-16, Koyasu-machi, Hachioji-shi, Tokyo, 192-0904, JP

(21) Appl. No.: 10/233,381

(22) Filed: Sep. 3, 2002

(30) Foreign Application Priority Data
Sep. 14, 2001 (JP) 2001-324237

(51) Int. Cl. G06F 17/60

(52) U.S. Cl. 705/35

(57) ABSTRACT

Assets are selected as fixed members of a portfolio and the proportion of value of each asset in the portfolio is determined. After some time period, the proportion of the value of each asset has changed because the price of some asset is not constant. Then, new amount of each asset is calculated so that the current proportion of the value of each asset comes close to the prefixed proportion of the value of each asset. The amount of each asset is adjusted accordingly. It is preferable to make the current proportion of the value of each asset becomes substantially equal to the prefixed proportion of the value of each asset.

### CROSS-REFERENCE TO RELATED APPLICATION

The present application is based upon and claims the benefit of priority from the prior Japanese Patent Application 2001-324237, filed Sep. 14, 2001, and the entire contents of the application are incorporated herein by reference.

### BACKGROUND OF THE INVENTION

1. Field of the Invention

The invention relates to a method and a system for asset management.

2. Description of the Related Art

An asset that has a marketability, which means the asset is sold and bought in a market and the price of the asset is determined in the market, changes it's market price dynamically. Because the asset price rises and falls, it is difficult for an investor to decide which time is suitable to buy the asset and which time is suitable to sell it. To reduce the risk of such volatility of the asset price, dollar cost averaging method (DCA) is well known in the art.

Dollar cost averaging method is suited for a long-term investment. An investor decides which asset he will buy regularly (usually monthly) and how much money he will spend to buy the asset. Because the investor always spends fixed amount of money, he buys larger amount of the asset when the price of the asset is low in the market, and he buys smaller amount of the asset when the price of the asset is high in the market. This feature lowers the average purchasing price of the asset.

It is experienced that prices of an asset is not kept constant in the market for a long term but repeatedly rises and falls for various factors. Dollar cost averaging method takes advantage of this volatility and provides an efficient long-term investment method.

But, dollar const averaging method is only applicable when an investor periodically buys the determined asset by the fixed amount of money, thus the remaining amount of the asset constantly increases. When the investor dislikes pouring money periodically for the investment, dollar cost averaging method is not applicable anymore.

Dollar cost averaging method has another deficiency. After long term investment, the ratio of the incremental amount of the asset to the remaining amount of the asset becomes relatively small compared with the early period. This is because the money to buy the asset is fixed and the remaining amount of the asset keeps increasing. Because of this aspect, the effect of buying the asset with the fixed amount of money is decreasing and the merit of dollar const averaging method is diminished as time goes.

This invention is made considering these situations.

### BRIEF SUMMARY OF THE INVENTION

This invention teaches a method for asset management, system for performing the method, a program product for enabling a computer to perform the method, and a method for producing information of asset management that uses the method.

The method comprises following steps: (1) acquiring information of the remaining amount of each asset in a portfolio consisting of fixed assets, and information of the current price of each asset in the portfolio; (2) calculating current value of each asset in the portfolio; and (3) adjusting remaining amount of each asset in the portfolio so that the proportion of the current value of each asset in the portfolio comes close to the prefixed proportion of the value of each asset in the portfolio. This method is performed repeatedly at predetermined timing.

The price of each asset in the portfolio fluctuates relatively because of the market, therefore the proportion of the value of each asset in the portfolio also relatively fluctuates. In this method, the proportion of the amount of an appreciated asset is decreased in the portfolio, and the proportion of the amount of a depreciated asset is increased in the portfolio. Nobody knows how the price of each asset will change in future, but in long time period, it fluctuates, it may not continue to rise or fall forever.

When the price of a previously appreciated asset falls, the potential loss is diminished, because the proportion of the amount of the asset in the portfolio has been decreased before its price goes down. Also, when the price of a previously depreciated asset rises, the profit is increased, because the proportion of the amount of the asset in the portfolio has been increased before its price rises. This invention tries to make a profit from the fluctuation of the price of assets. It should be noted that this invention does not guarantee any profit.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a schematic construction view showing the configuration of an asset managing system and its surroundings in the first embodiment and the second embodiment.

FIG. 2 is a flowchart showing the operation of the computer 1 with the asset management program in the first embodiment and the second embodiment.

FIG. 3 is a table showing an example of a process and a result of the asset management in the first embodiment.

FIG. 4 is a table showing an example of a process and a result of the asset management in the first embodiment.

FIG. 5 is a table showing an example of a process and a result of the asset management in the second embodiment.

### DETAILED DESCRIPTION OF THE INVENTION

Preferred embodiments of the present invention will be described hereinafter with reference to the drawings.

First, the concept of the invention will be described. This invention teaches an asset management method that has the initial stage and the following stages performed at predetermined timing. In the initial stage, a plural of assets are selected as members of a portfolio and a proportion of the value of each asset in the portfolio is determined and fixed. The portfolio consists of a plural of fixed assets that are selected in the initial stage. In the following each stages, the amount of each asset in the portfolio is adjusted so that a proportion of the current value of each asset in the portfolio comes close to the prefixed proportion.

A proportion of the value of an asset, which is prefixed in the initial stage, is called “a prefixed proportion of the value of an asset” hereinafter. A proportion of the value of an asset, which is calculated based on the current price of the asset, is called “a current proportion of the value of an asset” hereinafter. Adjustment of the amount of each asset so that the current proportion of the value of each asset comes close to the prefixed proportion of the value of each asset is called “smoothing” for short hereinafter. A typical smoothing is to adjust the amount of each asset so that the current proportion of the value of each asset becomes substantially equal to the prefixed proportion of the value of each asset. In this typical smoothing, change of the value in each asset is distinct, therefore typical smoothing offers a good benchmark to indicate whether an asset in the portfolio is appreciated or depreciated compared to the last smoothing.

Usually, asset price (value of a unit of an asset) is not kept constant but rises and falls according to the market, therefore the current proportion of the value of each asset in the portfolio fluctuates as time goes on. Even if an investor adjusts the remaining amount of each asset so that the current proportion of the value of each asset becomes substantially equal to the prefixed proportion, the current proportion of the value of each asset will depart from the prefixed proportion after some period.

If one asset's price increases than the average of the other assets of the portfolio, the current proportion of the value of the asset becomes higher than the prefixed proportion. This time, the asset is appreciated. On the contrary, if one asset's price decreases than the average of the other assets in the portfolio, the current proportion of the value of the asset becomes lower than the prefixed proportion. This time, the asset is depreciated.

This invention teaches to adjust the amount of each asset in the portfolio so that the current proportion of the value of each asset comes close to the prefixed proportion. Typically, this invention teaches to adjust the amount of each asset so that the current proportion of the value of each asset becomes substantially equal to the prefixed proportion.

By the adjustment, the current proportion of the value of a currently appreciated asset decreases and the current proportion of the value of a currently depreciated assets increases at the time. After some time period, the current proportion of the value of each asset changes again, so the current proportion of the value of each asset is adjusted to come close to the prefixed proportion. Because of the adjustment, the amount of each asset in the portfolio is changed (An appreciated asset decreases in proportion, a depreciated asset increases in proportion).

These adjustments are performed repeatedly at predetermined timing (for example, regularly or when the price of one asset changed more than a prefixed level), therefore the current proportion of the value of each asset is repeatedly adjusted according to its current price.

When the price of a previously appreciated asset falls, the potential loss is diminished, because the proportion of the asset amount in the portfolio has been decreased before its price goes down. Also, when the price of a previously depreciated asset rises, the profit is increased, because the proportion of the asset amount in the portfolio has been increased before its price rises. As mentioned before, an asset's price has volatility, it rises and falls, and it is very rare that the price keeps rising or falling eternally. The asset management of the invention tries to make a profit from the volatility.

There are two typical ways, though they are not all of the ways, for implementation of the asset management of the invention. The first one is managing assets without pouring additional money (without spending additional money for asset acquisition and without withdrawing some money from the portfolio). The second one is managing assets with pouring money regularly (with spending the money to acquire each asset accordingly thus increasing the amount of each asset in the portfolio), like dollar cost averaging method.

The first way will be described in the first embodiment, and the second way will be described in the second embodiment.

The First Embodiment

The first embodiment of the present invention will be described hereinafter with reference to the drawings. In the first embodiment, typical smoothing is adopted because it is easy to illustrate.

First, the merit of the management will be described mathematically. Assume an investor selects two assets, yen (currency) and dollar (currency), as fixed members of the portfolio, and fixes the proportion of the value of yen as 50% and the proportion of the value of dollar as 50%. In the initial stage, the investor acquires ¥a of yen and $b of dollar, and exchange rate is one dollar for r0 yen ($1=¥r0). Since the prefixed proportion of the value of yen and dollar are equal, it is clear that

a=r0*b.

The value of the remaining yen VY0 evaluated in yen is

¥VY0=¥a

The value of the remaining dollar VD0 evaluated in yen is

¥VD0=¥r0*b=¥a

Total of the value of the remaining both assets S0 evaluated in yen is

¥S0=¥VY0+¥VD0=2*¥a.

After some time period (in the first stage), the exchange rate becomes one dollar for r1 yen ($1=¥r1), therefore the value of the remaining dollar VD1 evaluated in yen is

¥VD1=¥r1*b.

On the other hand the value of the remaining yen VY1 evaluated in yen is unchanged (¥VD1=¥a). Thus, the total of the value of the remaining both assets S1 evaluated in yen is

¥S1=¥VY1+¥VD1=¥a+¥r1*b=¥a*(r0+r1)/r0.

By performing typical smoothing, the new value of the remaining of yen VY1 evaluated in yen is

¥VY1=¥a*(r0+r1)/(2*r0).

The new value of the remaining dollar VD1 evaluated in yen is

¥VD1=¥a*(r0+r1)/(2*r0).

After further time period (in the second stage), the exchange rate returns to the initial rate as one dollar for r0 yen ($1=¥r0), therefore the value of the remaining dollar VD2 evaluated in yen becomes

¥VD2=¥a*(r0+r1)/(2*r1).

The value of the remaining yen VY2 evaluated in yen becomes

¥VY2=¥a*(r0+r1)/(2*ro).

Thus, the total of the value of the remaining both assets S2 evaluated in yen becomes

¥S2=¥a*(r0+r1)*(r0+r1)/(2*r0*r1).

The profit P can be calculated by P=S2−S0, therefore the profit of the management evaluated in yen is

¥P=¥S2−¥S1=¥a*(r0−r1)*(r0−r1)/(2*r0*r1) (1).

It is clear from the formula (1) that the profit P can not be negative since every valuable takes positive value. The formula (1) suggests that the merit of the typical smoothing is proportional to the square of the discrepancy of r0 and r1.

As long as the exchange rate between dollar and yen fluctuate, timely smoothing operations can bring profits to an investor. Note that in the above example, costs for exchanging assets have not been considered for easiness.

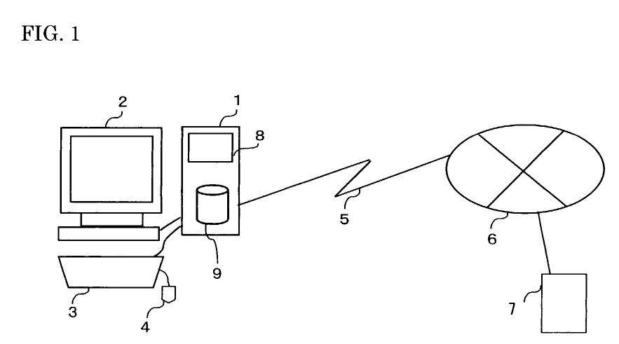

FIG. 1 shows the configuration of an asset managing system in the first embodiment and its surroundings. A computer 1 contains a processor (CPU) 8 and a hard disk drive 9 (a memory device). The computer 1 has a display 2 for displaying information, and a keyboard 3 and a mouse 4 as input devices. The computer 1 is connected to a network 6 though a communication line 5. The computer 1, the keyboard 3, and the mouse 4 are parts of an asset managing system. The computer 1 may be placed in a company for asset management, like an investment company. The hard disk drive 9 stores each investor's information used for the asset management. The stored information of each investor includes information identifying each asset consisting a portfolio as a fixed member (like name of each asset or code of each asset), information of the prefixed proportion of the value of each asset in the portfolio (like 30% for stock A, 40% for fund B, and 30% for stock C), and information of the remaining amount of each asset in the portfolio (like 1,000 shares of stock A, 500 units of fund B, 2,0000 shares of stock C). The asset management of the first embodiment is performed by loading an asset management program stored in the hard disk drive 9 into the main memory of the processor 8 and executing the program.

The network 6 may be the Internet, but other data communication path, like a leased line or a dedicated network, can be used. The network 6 is connected to other computer systems 7 as information sources or trading systems. These computer systems 7 as information sources offer information of the current price of various assets. These computer systems 7 as trading systems offer opportunities to acquire and dispose various assets. If the assets managed on the computer 1 include stock, a computer system of a stock exchange, like the Tokyo Stock Exchange, may be one of the computer systems 7. If the assets managed on the computer 1 include currency, a computer system of a foreign exchange, like the Tokyo Foreign Exchange, may be one of the computer systems 7. The computer systems 7 depend on the kinds of the assets managed on the computer 1.

Assets managed on computer 1 include, for example, stock, bond, currency (domestic and foreign), fund, option, future, precious metal (gold, silver, platinum, etc.), bank deposit (in a domestic currency and in a foreign currency). Since the method utilizes the volatility of the price of assets, at least one asset in the portfolio should have the volatility of the price. But it is not required that all assets in the portfolio have the volatilities, because one volatile asset in the portfolio gives relative volatilities to the price of the rest of the assets.

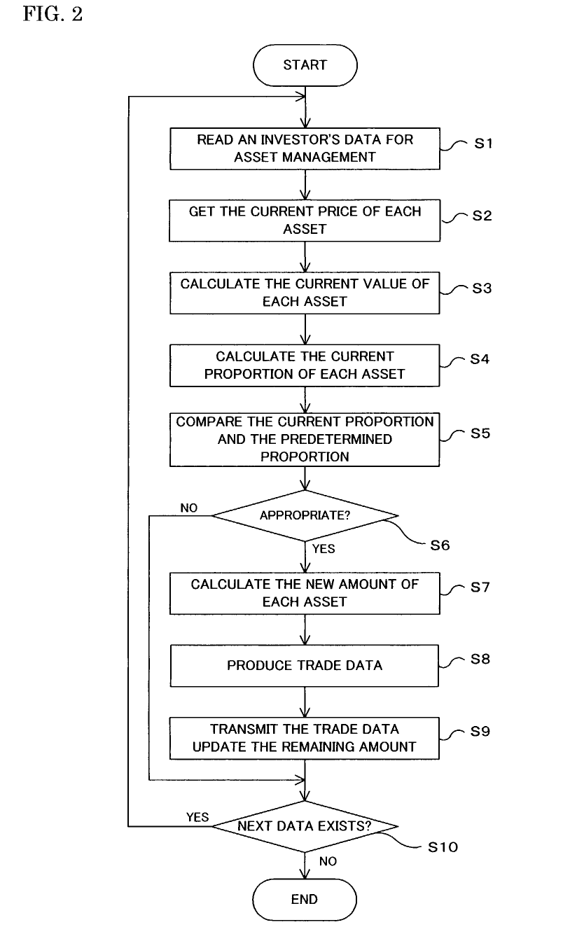

FIG. 2 is a flowchart showing the operation of the computer 1 with the asset management program.

Before performing this flow chart, each investor has chosen some assets as fixed members of the each investor's portfolio and fixed a proportion of the value of each asset in the portfolio as the prefixed proportion. These data have been stored in the hard disk drive 9 of the computer 1. The timing to do smoothing may be designated and registered in the hard disk drive 9 by each investor. Each investor can designate periodical timing, conditional timing or hybrid timing which is the combination of the periodical timing and the conditional timing. One example of the periodical timing is at the end of each month or at the first day of each week. One example of the conditional timings is when the discrepancy between the current proportion of an asset and the prefixed proportion of the asset becomes larger than a threshold vale (5% for example). The computer 1 checks the designated timing in each time. The process shown in FIG. 2 is performed frequently enough not to miss the designated timing.

Step S1: The computer 1 accesses its hard disk drive 9 and acquires an investor's information for the asset management. The acquired information includes information identifying each asset consisting a portfolio as a fixed member, information of the prefixed proportion of the value of each asset in the portfolio, and information of the remaining amount of each asset in the portfolio.

Step S2: The computer 1 accesses the other computer systems 7 through the data line 5 and the network 6, and acquires information of the current price of each asset in the portfolio.

Step S3: The computer 1 calculates the current value of each asset in the portfolio by multiplying the remaining amount of each asset by the current price of each asset.

Step S4: The computer 1 calculates the current proportion of the value of each asset in the portfolio by dividing the current value of each asset by the total of the current value of the portfolio.

Step S5: The computer 1 compares the current proportion and the prefixed proportion.

Step S6: The computer 1 decides whether it is appropriate to perform smoothing. If the investor has registered any timing beforehand, the computer 1 reads out the registered timing. If the current situation does not meet the registered timing, the computer 1 skips from step S7 to step S9 and performs step S10 to seek the next investor's data.

After the computer 1 checks the registered timing, it is desirable that the computer 1 further calculates a necessity or efficiency of smoothing. The reason will be described below. First, when the current proportion of the value of each asset is substantially equal to the prefixed proportion, there is no need to do smoothing. Second, even if the current proportion of the value of each asset in the portfolio is not substantially equal to the prefixed proportion, if the discrepancy between the current proportion and the prefixed proportion is small for some assets, smoothing may not be efficient, therefore it is better not to perform smoothing. This is because the cost for exchanging some amount of one asset to the other one in the portfolio might diminish a profit or make a loss.

To avoid making a loss in the management, a threshold value is determined in the first embodiment. When the discrepancy between the current proportion and the prefixed proportion is smaller than the threshold, the computer 1 decides not to perform smoothing and skips from step S7 to step S9 and performs the step S10. When the discrepancy is larger or equal to the threshold, the computer 1 performs the next step.

To reduce the profit erosion caused by the exchange cost, it is preferable to select an asset in which the exchange cost is not required or low. One example of such asset is a no-load fund. There are many no-load funds available today.

From Step S7 to Step S9, the computer 1 does smoothing, that is, adjusting the amount of the each asset so that the current proportion of the value of each asset in the portfolio comes close to the prefixed proportion. Since typical smoothing is adopted in the first embodiment, the amount of each asset is adjusted so that the current proportion of the vale of each asset becomes substantially equal to the prefixed proportion.

Step S7: The computer 1 calculates the new amount of each asset. The new amount of each asset may be calculated by, (1) adding all of the current value of each asset to get the total current value of the portfolio, (2) distributing the total current value of the portfolio to each asset according to the prefixed proportion of the value of each asset and (3) dividing the distributed value of each asset by the current price of each asset.

Step S8: The computer 1 calculates the difference of the current amount and the new amount in each asset, and produces trade data according to the difference of each asset calculated above.

Step S9: The computer 1 dispatches the trade data to the appropriate computer systems 7 as trading systems connected to the network 6 and acquires and disposes each asset accordingly therefore adjusts the amount of each asset of the portfolio. Thus, in the process of FIG. 2, the computer 1 produces information of asset management including the new remaining amount of each asset according to the results of the trade and data of the trade order for acquiring or disposing each asset.

Step 10: The computer 1 accesses the hard disk drive 9 and checks whether there are unprocessed investor's data. If any, the computer 1 picks one set of the unprocessed data and repeats from step S1 to step S9. If no data to be processed remains, the computer 1 ends the process of FIG. 2.

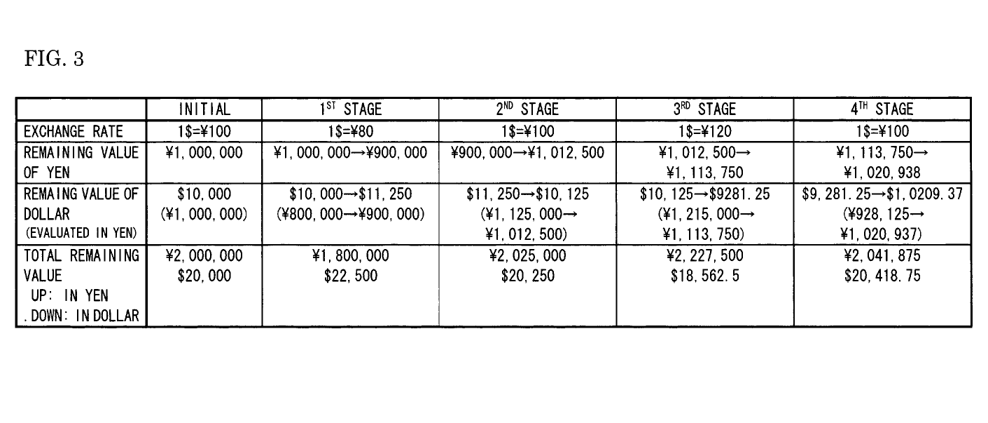

FIG. 3 shows an example of a process and a result of the asset management in the first embodiment. In this example, an investor chose two currencies, yen and dollar, as the fixed member of the portfolio and decided each asset's prefixed proportion of value was 50%. In the initial stage, the exchange rate between yen and dollar was one dollar for 100 yen ($1=¥100) and the investor acquired ¥1,000,000 and $10,000 (=¥1,000,000).

In the first stage, the exchange rate became 1$=¥80, then the value of the investor's $10,000 in yen became ¥800,000. On the other hand, the value of the ¥1,000,000 in yen unchanged. Thus, the total value of the investor's assets evaluated in yen became ¥1,800,000. At this time, the remaining amount of each asset was adjusted according to the prefixed proportion. Thus, the new amount of yen became ¥900,000 and the new amount of dollar became $11,250 (=¥900,000).

This kind of operation was performed in the second stage ($1=¥100), the third stage ($1=120) and the forth stage ($1=¥100) as shown in the FIG. 2. At the forth stage, before the adjustment, the remaining amount of yen was ¥1,113,750 and the remaining amount of dollar was $9281.25 and the total value of the two assets was ¥2,041,875. On the other hand, if this operation had not been performed, the total value of the two assets would have been ¥2,000,000. This operation yielded ¥41,875 as a profit.

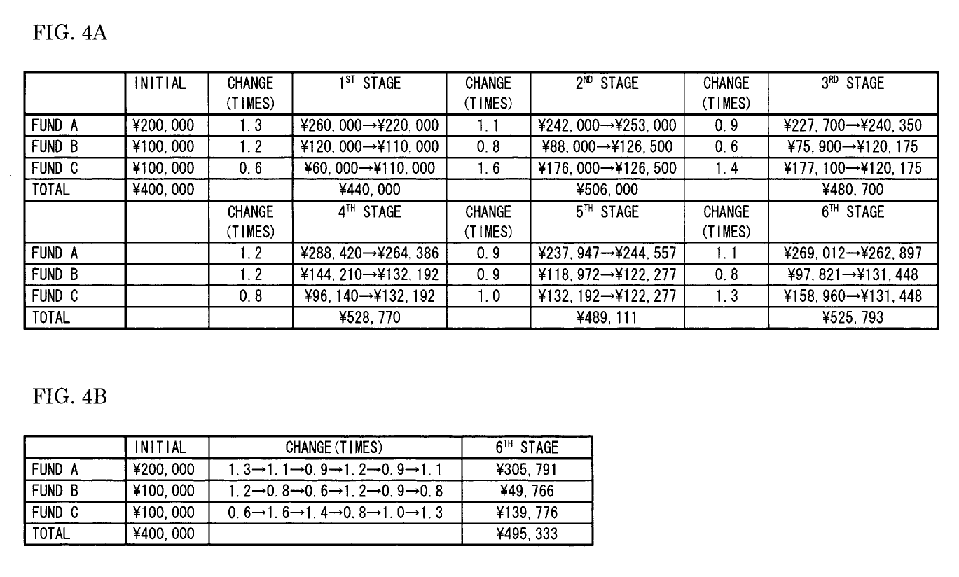

FIGS. 4A shows another example of a process and a result of the asset management in the first embodiment. In this example, an investor chose three mutual funds, fund A, fund B and fund C, and fixed fund A's prefixed proportion of the value as 50%, fund B's prefixed proportion of the value as 25% and fund C's prefixed proportion of the value as 25%. At the initial stage, fund A's remaining value was ¥200,000, fund B's remaining value was ¥100,000 and fund C's remaining value was ¥100,000, so the total of the assets value was ¥400,000.

From the initial stage to the first stage, fund A's value had changed to 1.3 times of the initial stage, fund B's value had changed to 1.2 times of the initial stage and fund C's value had change to 0.6 times of the initial stage.

From the first stage to the second stage, fund A's value had changed to 1.1 times of the first stage, fund B's value had changed to 0.8 times of the first stage and fund C's value had change to 1.6 times of the first stage.

From the second stage to the third stage, fund A's value had changed to 0.9 times of the second stage, fund B's value had changed to 0.6 times of the second stage and fund C's value had change to 1.4 times of the second stage.

From the third stage to the forth stage, fund A's value had changed to 1.2 times of the third stage, fund B's value had changed to 1.2 times of the third stage and fund C's value had change to 0.8 times of the third stage.

From the forth stage to the fifth stage, fund A's value had changed to 0.9 times of the forth stage, fund B's value had changed to 0.9 times of the forth stage and fund C's value had change to 1.0 times of the forth stage.

From the fifth stage to the sixth stage, fund A's value had changed to 1.1 times of the fifth stage, fund B's value had changed to 0.8 times of the fifth stage and fund C's value had change to 1.3 times of the fifth stage.

Under these conditions, FIG. 4A shows the history of the each fund's value when the asset management of the first embodiment was preformed. After sixth stage, fund A's value was ¥262,897, fund B's value was ¥131,448, fund C's value was ¥131,448 and the total value of the assets was ¥525,793.

FIG. 4B shows the value of each asset in the portfolio at the initial stage and the sixth stage when the asset management of the first embodiment was not performed. After sixth stage, fund A's value was ¥305,791, fund B's value was ¥49,766, fund C's value was 139,776, and the total value of the assets was ¥495,333. The asset management shown in FIG. 4 yielded ¥30,460.

The Second Embodiment

The second embodiment of the present invention will be described hereinafter with reference to the drawings.

In the second embodiment, the assets in the portfolio are acquired regularly with fixed amount of money. For each asset, acquired amount is decided according to the way of smoothing, that is, acquiring each asset so that the current proportion of the value of the each asset comes close to the prefixed proportion. The second embodiment adopts the typical smoothing because it is easy to illustrate. The typical smoothing requires acquiring each asset in the portfolio so that the current proportion of the value of each asset in the portfolio becomes substantially equal to the prefixed proportion.

The second embodiment uses the configuration shown FIG. 1 as in the first embodiment. Since the data stored in the hard disk drive 9 and the software loaded in the computer 1 are different a little from those of the first embodiment, the different parts will be mainly described from now on.

The process and the data of the second embodiment are described with reference of FIG. 2. FIG. 2 is a flowchart showing the operation of the computer 1 with the asset management program.

Before performing this flow chart, each investor has decided specific assets and their prefixed proportion and registered them in the computer 1. In the second embodiment, each investor also has decided the amount of money to be spent each time and timing to acquire each asset, and registered them in the computer 1.

Unlike the first embodiment, the second embodiment does not exchange one asset to other assets, therefore an investor needs not much worry about the exchange fee. Thus, timing may be set periodically and the discrepancy of the prefixed proportion and the current proportion may not be considered so much. It should be noted that even in the second embodiment, the discrepancy is still important, because the merit of the smoothing is related to the square of the discrepancy as shown in formula (1). The process shown in FIG. 2 is performed frequently enough not to miss the timing.

Step S1: The computer 1 accesses its hard disk drive 9 and acquires an investor's information for the asset management. The acquired information includes information identifying each asset consisting a portfolio as a fixed member, information of the prefixed proportion of the value of each asset in the portfolio, and information of the remaining amount of each asset in the portfolio. In the second embodiment the information also includes information of the amount of money to be used for acquiring some of assets in the portfolio in each time.

Step S2: The computer 1 accesses the other computer systems 7 through the data line 5 and the network 6 and acquires information of the current price of each asset in the portfolio.

Step S3: The computer 1 calculates the current value of each asset by multiplying the remaining amount of each asset by the current price of each asset.

Step S4: The computer 1 calculates the current proportion of the value of each asset in the portfolio by dividing the current value of each asset by the total of the current value of the portfolio.

Step S5: The computer 1 compares the current proportion and the prefixed proportion.

Step S6: The computer 1 decides whether it is appropriate to do smoothing. The computer 1 reads out the registered timing and decides the current situation is suitable or not. If the current situation is suitable, the computer 1 performs the next step, and if not, the computer 1 skips from step S7 to step S9, and performs step S10.

From Step S7 to Step S9, the computer 1 performs typical smoothing, that is, acquiring each asset so that the current proportion of the value of each asset in the portfolio becomes substantially equal to the prefixed proportion.

Step S7: The computer 1 calculates the new amount of each asset. The new amount of each asset may be calculated by (1) adding all of the current value of each asset to get the total value of the portfolio, (2) adding the value of money to be spent for acquiring assets to the total value of the portfolio to get the new total value of the portfolio, (3) splitting the new total value of the portfolio according to the prefixed proportion of the value of each asset to get a new value of each asset, (4) dividing the new value of each asset by the current price of each asset.

In step S7, the new amount of an asset can be lesser than the current amount of the asset when the money to be spent is small in relation to the whole value of the portfolio. In such case, the current amount of the asset is used as the new amount of the asset, even if this makes the other asset's new amount lowers than the calculated new amount.

Step S8: The computer 1 calculates the difference of the current amount and the new amount in the each asset, and produces trade data according to the differences calculated above.

Step S9: The computer 1 dispatches the trade data to the appropriate external market systems 7 as trading systems connected to the network 6 and acquires each asset accordingly therefore adjusts the amount of each asset of the portfolio. Thus, in the process of FIG. 2, the computer 1 produces information of the asset management including the new remaining amount of each asset in the portfolio according to the results of the trade, and data of the trade order for acquiring and disposing each asset.

Step 10: The computer 1 accesses the hard disk drive 9 and checks whether there are unprocessed investor's data. If any, the computer 1 picks one of the unprocessed data and repeats from step S1 to step S9. If no data to be processed remains, the computer 1 ends the process of FIG. 2.

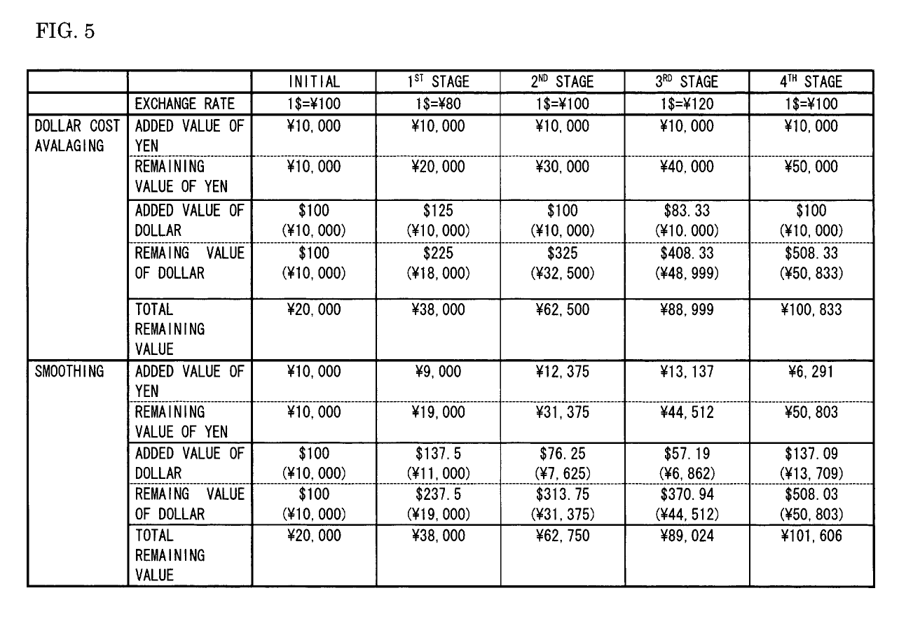

FIG. 5 shows an example of a process and a result of the asset management in the second embodiment. FIG. 5 uses the same situations as those of FIG. 3.

The upper part of the table shows a case of dollar cost averaging method presented for comparison. The lower part of the table shows a case of smoothing.

In this example, an investor chose two currencies, yen and dollar, as fixed member assets of the portfolio and decided the each asset's prefixed proportion of the value was 50%. In each stage, the investor spent ¥20,000 for acquiring each asset. In case of dollar cost averaging, the investor split ¥20.000 and spent ¥10,000 for yen and ¥10,000 for dollar. In case of smoothing, the investor split ¥20,000 so that the remaining value of yen and dollar becomes substantially equal after the acquisition.

From the initial stage to the first stage, the investor has poured total ¥100,000 to acquire yen and dollar in both cases. In dollar cost averaging, the investor had ¥100,833 after the forth stage. In smoothing, the investor had ¥101,606 after the forth stage. The management of smoothing had earned ¥773 more than the management of dollar cost averaging.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is

1. A method for asset management, which is repeatedly performed at predetermined timing, comprising:
(1) acquiring information of the remaining amount of each asset in a portfolio consisting of fixed assets, and information of the current price of each asset in the portfolio;
(2) calculating the current value of each asset in the portfolio; and
(3) adjusting the remaining amount of each asset in the portfolio so that the proportion of the current value of each asset in the portfolio comes close to the prefixed proportion of value of each asset in the portfolio.

2. The method for asset management according to claim 1, wherein the adjustment of the remaining amount of each asset in the portfolio is performed so that the proportion of the current value of each asset in the portfolio becomes substantially equal to the prefixed proportion of the value of each asset in the portfolio.

3. The method for asset management according to claim 1, wherein the predetermined timing is periodical timing.

4. The method for asset management according to claim 1, wherein the predetermined timing is when the discrepancy between the proportion of the current value of an asset in the portfolio and the prefixed proportion of the value of the asset in the portfolio becomes larger than a predetermined threshold.

5. The method for asset management according to claim 1, wherein the adjustment is made by increasing the amount of each asset in the portfolio accordingly.

6. The method for asset management according to claim 1, wherein the adjustment is made without spending additional money for asset acquisition and without withdrawing some money from the portfolio.

7. The method for asset management according to claim 1, wherein the method is performed on a computer.

8. A computer system adapted for asst management comprising:
a processor, and
a memory including software instructions, which are repeatedly performed at predetermined timing, adapted to enable the computer system to perform:
(1) acquiring information of the remaining amount of each asset in a portfolio consisting of fixed assets, and information of the current price of each asset in the portfolio;
(2) calculating current value of each asset in the portfolio; and
(3) calculating remaining amount of each asset in the portfolio, for adjusting the remaining amount of each asset accordingly, so that the proportion of the current value of each asset in the portfolio comes close to the prefixed proportion of the value of each asset in the portfolio.

9. The computer system according to claim 8, wherein the calculation of the remaining amount of each asset in the portfolio is performed so that the proportion of the current value of each asset in the portfolio becomes substantially equal to the prefixed proportion of the value of each asset in the portfolio.

10. The computer system according to claim 8, wherein the predetermined timing is periodical timing.

11. The computer system according to claim 8, wherein the predetermined timing is when the discrepancy between the proportion of the current value of an asset in the portfolio and the prefixed proportion of the value of the asset in the portfolio becomes larger than a predetermined threshold.

12. The computer system according to claim 8, wherein the calculation of the remaining amount of each asset in the portfolio is made under the condition that the adjustment is to be made by increasing the amount of each asset in the portfolio accordingly.

13. The computer system according to claim 8, wherein the calculation of the remaining amount of each asset in the portfolio is made under the condition that the adjustment is to be made without spending additional money for asset acquisition and without withdrawing some money from the portfolio.

14. A computer program product adapted for enabling a computer to perform asst management comprising:
software instructions for enabling the computer to perform predetermined operations, and
a computer readable medium embodying the software instructions;
the predetermined operations, which are repeatedly performed at predetermined timing, comprising:
(1) acquiring information of the remaining amount of each asset in a portfolio consisting of fixed assets, and information of the current price of each asset in the portfolio;
(2) calculating current value of each asset in the portfolio; and
(3) calculating remaining amount of each asset in the portfolio, for adjusting the remaining amount of each asset accordingly, so that the proportion of the current value of each asset in the portfolio comes close to the prefixed proportion of the value of each asset in the portfolio.

15. The computer program product according to claim 14, wherein the calculation of the remaining amount of each asset in the portfolio is performed so that the proportion of the current value of each asset in the portfolio becomes substantially equal to the prefixed proportion of the value of each asset in the portfolio.

16. The computer program product according to claim 14, wherein the predetermined timing is periodical timing.

17. The computer program product according to claim 14, wherein the predetermined timing is when the discrepancy between the proportion of the current value of an asset in the portfolio and the prefixed proportion of the value of the asset in the portfolio becomes larger than a predetermined threshold.

18. The computer program product according to claim 14, wherein the calculation of the remaining amount of each asset in the portfolio is made under the condition that the adjustment is to be made by increasing the amount of each asset in the portfolio accordingly.

19. The computer program product according to claim 14, wherein the calculation of the remaining amount of each asset in the portfolio is made under the condition that the adjustment is to be made without spending additional money for asset acquisition and without withdrawing some money from the portfolio.

20. A method for producing information of asset management, which is repeatedly performed at predetermined timing, comprising:
(1) acquiring information of the remaining amount of each asset in a portfolio consisting of fixed assets, and information of the current price of each asset in the portfolio;
(2) calculating current value of each asset in the portfolio;
(3) adjusting remaining amount of each asset in the portfolio so that the proportion of the current value of each asset in the portfolio comes close to the prefixed proportion of the value of each asset in the portfolio; and
(4) producing information of asset management indicating a result of the adjustment.

21. The method for producing information of asset management according to claim 20, wherein the adjustment of the remaining amount of each asset in the portfolio is performed so that the proportion of the current value of each asset in the portfolio becomes substantially equal to the prefixed proportion of the value of each asset in the portfolio.

22. The method for producing information of asset management according to claim 20, wherein the predetermined timing is periodical timing.

23. The method for producing information of asset management according to claim 20, wherein the predetermined timing is when the discrepancy between the proportion of the current value of an asset in the portfolio and the prefixed proportion of the value of the asset in the portfolio becomes larger than a predetermined threshold.

24. The method for producing information of asset management according to claim 20, wherein the adjustment is made by increasing the amount of each asset in the portfolio accordingly.

25. The method for producing information of asset management according to claim 20, wherein the adjustment is made without spending additional money for asset acquisition and without withdrawing some money from the portfolio.

26. The method for producing information of asset management according to claim 20, wherein the method is performed on a computer.
